(19) United States
(12) Patent Application Publication
(10) Pub. No.: US 2004/0016316 A1
(43) Pub. Date: Jan. 29, 2004

(54) Adjustable extended riser

(76) Inventor: Michael Bechler, Palo Alto, CA (US)

Correspondence Address: Michael Bechler, 2533 Middlefield Rd., Palo Alto, CA, 94301, US

(21) Appl. No.: 10/200,680

(22) Filed: Jul. 23, 2002

(51) Int. Cl. B62K 21/16

(52) U.S. Cl. 74/551.3

(57) ABSTRACT

A device that provides the means to allow the operator of any handlebar-operated vehicle, craft or other device to quickly and easily change the handlebar position. It is installed between the original riser and the handlebar. It consists of: a) A structure that is shaped like a portion of the original handlebars. This mounts in the original riser or other mounting hardware. b) A structure that secures the handlebars in place. c) A structure that connects “a” and “b”. The operator can adjust the handlebar position by loosening the securing hardware on the original riser, moving the handlebar to the desired position by swiveling, the adjustable extended riser, then re-tightening the securing hardware on the original riser.

### FEDERALLY SPONSORED RESEARCH

Not Applicable

### SEQUENCE LISTING OR PROGRAM

Not Applicable

### BACKGROUND—FIELD OF INVENTION

This invention relates to any handlebar-controlled vehicle or device including but not limited to motorcycles, bicycles, ATVs, snowmobiles, or watercraft.

### BACKGROUND—DESCRIPTION OF PRIOR ART

On many handlebar-controlled vehicles, the handlebars are mounted on a riser, which is a rigid structure with a clamp or set of clamps that secure the handlebars in place. An example appears in FIG. 1.

This design provides an extremely limited range of adjustability; all the operator can do is to rotate the handlebars in place. To move them up or down, or forwards or backwards requires replacing the riser or the handlebars with one of a different shape. This is a time-consuming process that requires a skilled mechanic, and is therefore most often done in a shop.

My invention improves this design by providing a means for easily adjusting the position of the handlebars up and down, and forwards and backwards.

U.S. Pat. No. 5,509,328 describes an adjustable riser specifically for a bicycle; this provides a similar adjustability. My invention improves this design because a) it is less complicated. b) it does not require replacement of any original equipment, c) it provides a greater range of motion, and d) it applies to any handlebar-controlled vehicle, craft or other device, where U.S. Pat. No. 5,509,328 is limited to a bicycle.

### OBJECTS AND ADVANTAGES

The adjustable extended riser provides a means for easily and quickly adjusting the position of the handlebars. It requires using few tools, and can be done quickly by a person with limited mechanical skill. Also, it can be installed without removing or replacing the original riser, or the original handlebars.

Further advantages might become apparent from viewing the Figures or reading the following text.

### SUMMARY

This invention is installed between the risers and the handlebars of any handlebar-controlled vehicle, craft or device. It connects to the original riser like a set of handlebars, and it provides a mechanism to secure the original handlebars. It provides a means to easily adjust the position of the handlebars.

### DRAWING FIGURES

FIG. 1—Prior Art, Handlebar and Riser

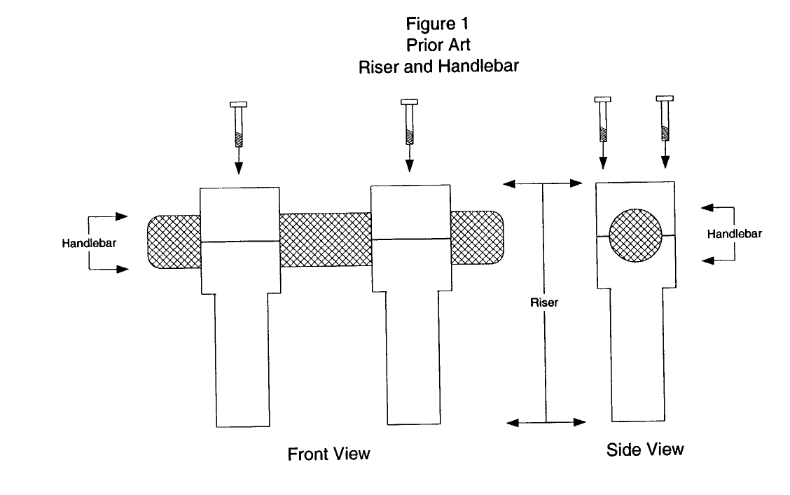

FIG. 2—Extended Adjustable Riser, Front and Side View

2-A—Hardware for Securing Handlebars

2-B—Structure Connecting 2-A and 2-C

2-C—Simulated Handlebar for Mounting in Original Riser

FIG. 3—Typical Application—Adjustable Extended Riser mounted on motorcycle

FIG. 4—Range of Motion

### DETAILED DESCRIPTION

Preferred Embodiment

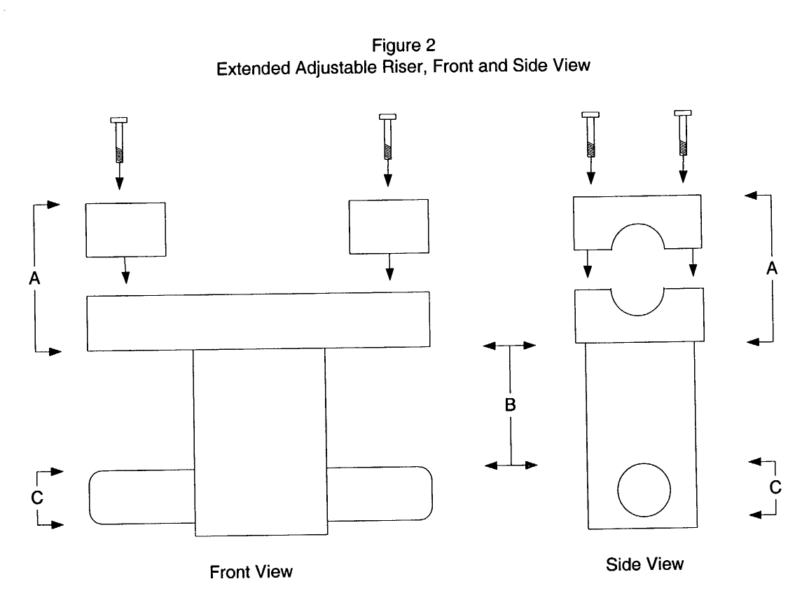

A preferred embodiment of the adjustable extended riser appears in FIG. 2.

This device sits between the riser (or other mounting hardware) and the handlebar on any handlebar-operated vehicle, craft or other device.

FIG. 2 shows frontal and side views of this device. Please note that the example in these figures is designed for a specific type of motorcycle.

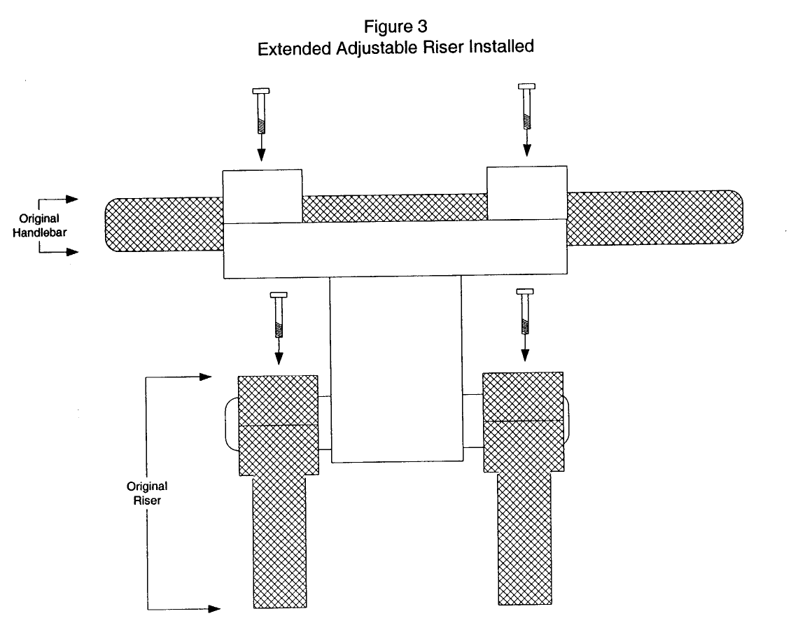

FIG. 3 shows the device mounted in a typical motorcycle.

One end of this device is shaped like the portion of the original handlebars that is secured in the original riser. It is mounted in the original riser (or other securing hardware) as if it were a set of handlebars. See FIG. 2-C and FIG. 3.

The other end of this device secures the handlebars in place. See FIG. 2-A and FIG. 3.

The center of this device is a structure that connects the two ends. It is shown in FIG. 2-B.

FIG. 3 shows an example of how the device looks installed on a typical motorcycle. This is a drawing of an actual prototype that is installed in a 1995 Honda Magna.

Please note that this device can be shaped many different ways, depending on the application, required strength, material, and for aesthetics. However the basic principle is the same, as described above.

Additional Embodiment

There are many possible ways to secure handlebars in place. The hardware that secures the handlebars in place does not have to look like or operate like the hardware on the original riser. Any mechanism that secures the handlebars properly and loosens easily for adjustment can be used.

Alternative Embodiment

The length of the center portion of the adjustable extended riser can vary in length depending on the application, the desire of the owner or installer, or other factors.

Advantages

From the above description, a number of advantages become apparent:

a) This device provides a means for adjusting the handlebars easily through a wide range of positions, thus avoiding the need to replace handlebars or the riser to change the handlebar position.

b) This device is easy to install.

c) This device does not require the replacement or removal of any original equipment.

Operation

The extended adjustable riser (the device) provides an easy method of adjusting the handlebar position on any handlebar-operated vehicle, craft or device.

The device is installed between the handlebars and the riser. One end of the device acts like a portion of the handlebars, it attaches to the original riser as if it were a set of handlebars. The other end of the device acts like the top of a riser; it is used to secure the handlebars in place.

Once the device is installed, to change the handlebar position, the user loosens the mounting hardware on the original riser, and the handlebar-mounting hardware on the extended adjustable riser. They can then:

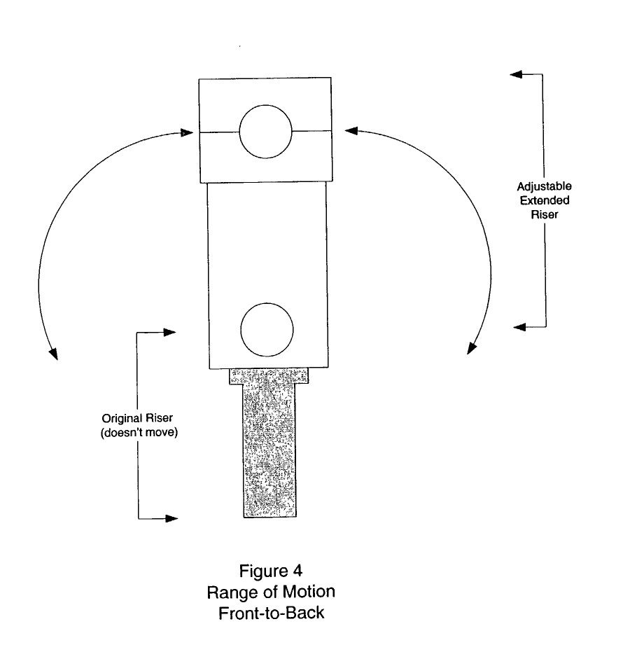

a) swivel the adjustable extended riser to move the handlebars forward and backwards through an are described by the length of the adjustable extended riser and pivoting around the point where the adjustable extended riser attaches to the original riser. A typical range of motion appears in FIG. 4.

b) rotate the handle bars around the point where they are secured on the extended riser.

When the handlebars are in the desired position, the user re-tightens the mounting hardware on the original riser and on the extended riser.

These two movements provide a wide degree of adjustability

### CONCLUSIONS, RAMIFICATIONS AND SCOPE

The adjustable extended riser allows users to easily adapt their riding position to current conditions quickly, in the field if necessary. This will result in increased comfort control, ergonomics and safety.

While the drawings show the mounting hardware for a motorcycle, many variations are possible, including but not limited to bicycles, snow mobiles, ATVs, and watercraft.

Accordingly, the scope of this invention should not be determined by the embodiments illustrated, but by the appended claims and their legal equivalents.

What I claim as my invention is:

1. A device that provides a means for easily adjusting the position of handlebars on a bicycle, motorcycle, watercraft, ATV or other handlebar-controlled vehicle consisting of:
a) a structure that is shaped like the portion of the original handlebar and that mounts in the original riser or other mounting hardware like the original handlebar,
b) a structure that secures the handlebar in place
c) a structure that connects them.
